(19) United States
(12) Patent Application Publication
(10) Pub. No.: US 2025/0055150 A1
(43) Pub. Date: Feb. 13, 2025

(54) BATTERY MODULE

(71) Applicant: TOYOTA JIDOSHA KABUSHIKI KAISHA, Toyota-shi (JP)

(72) Inventors: Shinya ISHIKAWA, Anjo-shi (JP); Takashi Miura, Nagoya-shi (JP); Tetsuya Mimura, Chiryu-shi (JP); Toshihiro Shimonaka, Toyota-shi (JP); Yuki Hirata, Chigasaki-shi (JP); Masayoshi Haga, Nagoya-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 18/655,516

(22) Filed: May 6, 2024

(30) Foreign Application Priority Data
Aug. 8, 2023 (JP) 2023-129553

(51) Int. Cl. H01M 50/516; H01M 50/249; H01M 50/507

(52) U.S. Cl. CPC H01M 50/516; H01M 50/249; H01M 50/507

(57) ABSTRACT

The battery module includes a plurality of battery cells stacked on each other, an electrode lead protruding from the battery cell, and a bus bar electrically joined to the electrode lead via a welded portion, the welded portion being formed so as to straddle the end portions of the plurality of electrode leads on a surface where the end portions of the plurality of electrode leads approach each other.

### CROSS-REFERENCE TO RELATED APPLICATION

This application claims priority to Japanese Patent Application No. 2023-129553 filed on Aug. 8, 2023, incorporated herein by reference in its entirety.

### BACKGROUND

### 1. Technical Field

The present disclosure relates to a battery module.

### 2. Description of Related Art

Japanese Patent No. 7062162 discloses a battery module including a plurality of battery cells stacked on each other, and a bus bar unit electrically connected to electrode leads of the battery cells. In this battery module, end portions of the two electrode leads are collected on a bus bar unit, and joined to each other through welding or the like.

### SUMMARY

When the end portions of the electrode leads are welded on the bus bar, it is desirable that the electrode leads should be welded at the same time from the viewpoint of reducing the number of man-hours.

However, when the end portions of the two electrode leads are vertically superimposed on each other to be welded at the same time, as in the battery module disclosed in Japanese Patent No. 7062162, the output of the welding machine is increased and the cost is increased.

In view of the above, it is an object of the present disclosure to provide a battery module capable of achieving both a reduction in number of man-hours and a reduction in cost for a welded portion between a bus bar and a plurality of electrode leads.

A first aspect provides a battery module including: a plurality of battery cells stacked on each other; electrode leads that protrude from the battery cells; and a bus bar electrically connected to the electrode leads via a welded portion, the welded portion being formed to extend between respective end portions of the electrode leads on a surface of the bus bar on which the end portions of the electrode leads are close to each other.

The battery module according to the first aspect includes a plurality of battery cells stacked on each other. The electrode leads that protrude from the respective battery cells are electrically connected to the bus bar via the welded portion. Here, the welded portion that joins the electrode leads and the bus bar is formed to extend between the respective end portions of the electrode leads on the surface of the bus bar on which the end portions of the electrode leads are close each other. Consequently, the electrode leads can be joined to the bus bar side at the same time via a common welded portion, thereby reducing the number of man-hours for welding. Further, since the welded portion is formed to extend between the respective end portions of the electrode leads, the output of the welding machine can be reduced as compared with a configuration in which the end portions of the electrode leads are vertically superimposed on each other along the joining direction to be welded, thereby reducing the cost of welding.

Here, “the end portions of the electrode are close to each other” is a broad concept including both a state in which the end portions of the electrode leads are in contact with each other and a state in which the end portions of the electrode leads are not in contact but are close to each other.

A second aspect provides the battery module according to the first aspect, in which the welded portion is formed in a dot shape when seen in a joining direction of the welded portion.

In the battery module according to the second aspect, the welded portion is formed in a dot shape when seen in a joining direction of the welded portion. Thus, it is possible to join the electrode leads to the bus bar side via the dot-shaped welded portion through laser welding or the like. Consequently, the range of the welded portion can be reduced, and the distortion and the welding burn of the base material due to the welding heat can be suppressed, thereby reducing the number of man-hours for finishing.

A third aspect provides the battery module according to the first or second aspect, in which a heat input portion is formed at the welded portion in at least either of the electrode leads and the bus bar, the heat input portion having a higher heat input property in a joining direction than other portions.

In the battery module according to the third aspect, a heat input portion is formed at the welded portion in at least either of the electrode leads and the bus bar, the heat input portion having a higher heat input property in a joining direction than other portions. As a result, the penetration of the base material of the welded portion can be deepened by the heat input portion, stabilizing the joint.

A fourth aspect provides the battery module according to the third aspect, in which the heat input portion is formed by surface processing to increase a surface area of the welded portion.

In the battery module according to the fourth aspect, the heat input property of the welded portion in the joining direction is enhanced by increasing the surface area of the welded portion through surface processing of the heat input portion. Consequently, the penetration of the base material of the welded portion can be deepened, stabilizing the joint.

A fifth aspect provides the battery module according to the third aspect, in which the heat input portion is formed by surface processing to apply a black material to the welded portion.

In the battery module according to the fifth aspect, the heat input property of the welded portion in the joining direction is enhanced by applying a black material to the welded portion through surface processing of the heat input portion. Consequently, the penetration of the base material of the welded portion can be deepened, stabilizing the joint.

As described above, with the battery module according to the present disclosure, it is possible to achieve both a reduction in number of man-hours and a reduction in cost for a welded portion between a bus bar and a plurality of electrode leads.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating a main part of a vehicle to which a battery pack according to an embodiment is applied;

FIG. 2 is a schematic perspective view of a battery module according to an embodiment;

FIG. 3 is a plan view of the battery module according to the embodiment, with the upper lid of the module case removed;

FIG. 4 is a schematic view of a battery cell accommodated in a battery module viewed from a thickness direction;

FIG. 5 is a schematic plan view showing a state in which a plurality of battery cells is accommodated in a module case in a partially enlarged manner;

FIG. 6A is an enlarged front view of a welded portion joining a plurality of electrode leads and a bus bar, as viewed from an A direction of FIG. 5;

FIG. 6B is an enlarged cross-sectional view illustrating a cross section taken along B-B line of FIG. 6A;

FIG. 7A is an enlarged cross-sectional view corresponding to FIG. 6B that shows an example of a heat input portion formed in the welded portion;

FIG. 7B is an enlarged cross-sectional view corresponding to FIG. 6B that shows an example of the heat input portion formed in the welded portion;

FIG. 7C is an enlarged cross-sectional view corresponding to FIG. 6B that shows an example of the heat input portion formed in the welded portion;

FIG. 7D is an enlarged cross-sectional view corresponding to FIG. 6B that shows an example of the heat input portion formed in the welded portion; and

FIG. 7E is an enlarged cross-sectional view corresponding to FIG. 6B that shows an example of the heat input portion formed in the welded portion.

### DETAILED DESCRIPTION OF EMBODIMENTS

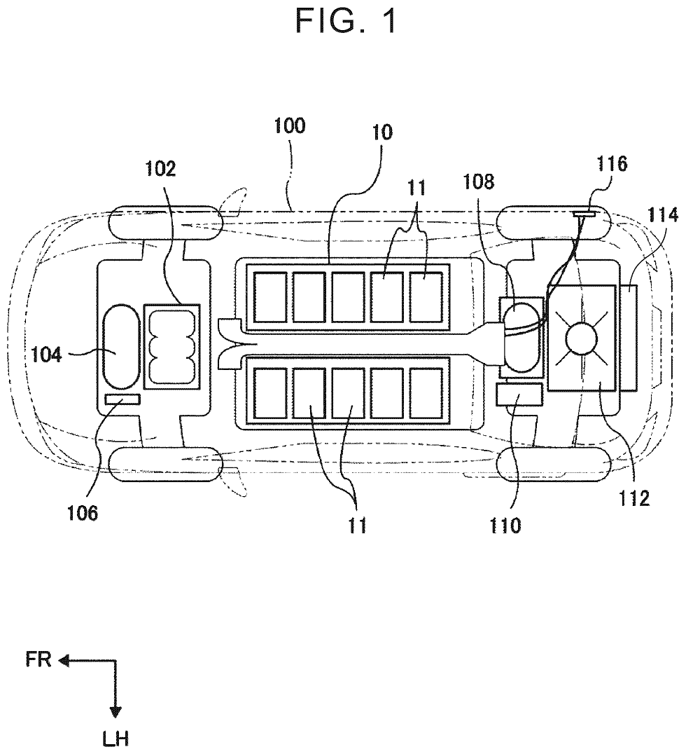

Referring to FIGS. 1 to 6B, an embodiment of the present disclosure will be described below.

### Overall Configuration of Vehicle 100

FIG. 1 is a schematic plan view showing a main part of a vehicle 100 to which a battery pack 10 according to an embodiment is applied. As illustrated in FIG. 1, the vehicle 100 is a battery electric vehicle (BEV) in which the battery pack 10 is mounted under the floor. Note that the arrow UP, the arrow FR, and the arrow LH in the drawings respectively indicate the upper side in the vehicle up-down direction, the front side in the vehicle front-rear direction, and the left side in the vehicle widthwise direction. In the case where the front, rear, left, right, and up and down directions are used and described, unless otherwise specified, the front and back directions in the vehicle front-rear direction, the left and right directions in the vehicle width direction, and the up and down directions in the vehicle up and down directions are indicated.

In the vehicle 100 of the present embodiment, DC/DC converters 102, the electric compressor 104, and Positive Temperature Coefficient (PTC) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverter 112, and the like. Further, electric power is supplied to the motor 108 via the inverter 112, so that the rear wheels rotate to drive the vehicle 100.

A charging port 116 is provided at a right side portion of a rear portion of the vehicle 100. When a charging plug of an external charging facility (not shown) is connected from the charging port 116, electric power can be stored in the battery pack 10 via the in-vehicle charger 114.

Note that the arrangement, structure, and the like of the components constituting the vehicle 100 are not limited to the above-described configurations. For example, it may be applied to an engine-mounted hybrid electric vehicle (HV) or plug-in hybrid electric vehicle (PHEV). Further, in the present embodiment, the motor 108 is a rear-wheel-driven vehicle mounted on the vehicle rear portion, but the present disclosure is not limited thereto, and the motor 108 may be a front-wheel-driven vehicle mounted on the vehicle front portion, or a pair of motors 108 may be mounted on the vehicle front and rear. Further, the vehicle may be provided with an in-wheel motor for each wheel.

Here, the battery pack 10 includes a plurality of battery modules 11. In the present embodiment, as an example, 10 battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

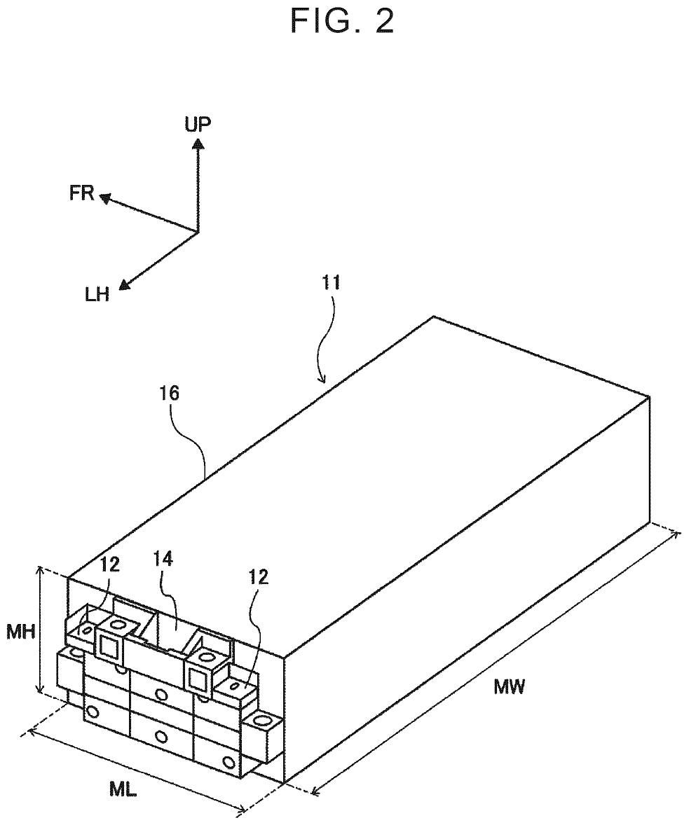

FIG. 2 is a schematic perspective view of the battery module 11. As shown in FIG. 2, the battery module 11 includes a module case 16 forming an outer shell. The module case 16 is formed in a substantially rectangular parallelepiped shape having a vehicle width direction as a longitudinal direction. The module case 16 is made of an aluminum alloy. For example, the module case 16 is formed by joining aluminum die-casting to both ends of an extruded material of an aluminum alloy by laser welding or the like.

A pair of voltage terminals 12 and a connector 14 are provided at both end portions of the battery module 11 in the vehicle width direction, respectively. A flexible printed circuit board 21, which will be described later, is connected to the connector 14. A bus bar 30 (see FIG. 4) is welded to both end portions of the battery module 11 in the vehicle width direction.

The length MW of the battery module 11 in the vehicle width direction is, for example, 600 mm from 350 mm, the length ML in the vehicle front-rear direction is, for example, 250 mm from 150 mm, and the height MH in the vehicle vertical direction is, for example, 110 mm from 80 mm.

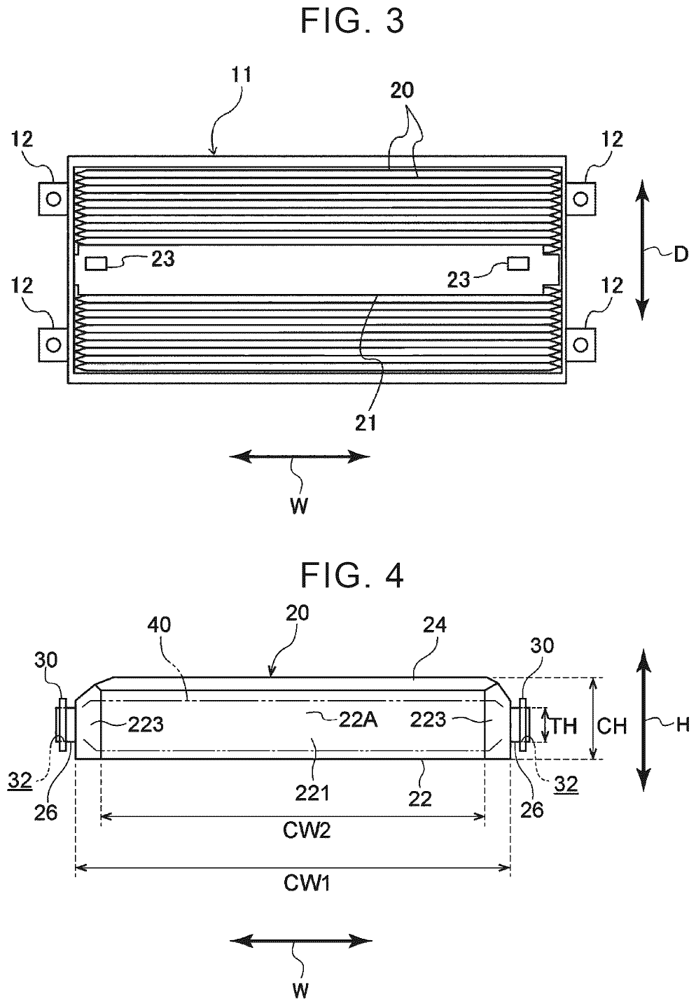

FIG. 3 is a plan view of the battery module 11 with the upper lid removed. As shown in FIG. 3, a battery cell 20 as a battery is accommodated in the module case 16. As an example, a plurality of battery cells 20 are accommodated in a state of being arranged (stacked) in the module case 16. In the present embodiment, the 24 battery cells 20 are arranged in the vehicle front-rear direction and adhered to each other.

For case of explanation, in the drawings of FIGS. 3 to 6A, the direction indicated by the arrow W is the width direction of the battery cell 20, the direction indicated by the arrow H is the height direction (vertical direction) of the battery cell 20, and the direction indicated by the arrow D is the thickness direction of the battery cell 20. The width direction of the battery case 22 described later coincides with the width direction W of the battery cell 20. The height direction of the battery case 22 coincides with the height direction H of the battery cell 20. The thickness direction of the battery case 22 coincides with the thickness direction D of the battery cell 20.

A Flexible Printed Circuit (FPC) 21 is disposed on the battery cell 20. The flexible printed circuit board 21 is formed in a band shape with the vehicle width direction as a longitudinal direction. Thermistors 23 are provided at both ends of the flexible printed circuit board 21. The thermistor 23 is not adhered to the battery cell 20 and is pressed toward the battery cell 20 by the upper lid of the battery module 11.

One or more cushioning materials (not shown) are accommodated in the module case 16. For example, the cushioning material is an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the module case 16 and at a central portion in the longitudinal direction, respectively.

FIG. 4 is a schematic view of the battery cell 20 accommodated in the battery module 11 viewed from the thickness direction D. As shown in FIG. 4, the battery cell 20 is formed in an elongated rectangular plate shape having a width direction W as a longitudinal direction, and includes a battery case 22 forming an outer shell. The electrode body 40 is accommodated in the battery case 22. The electrode body 40 is formed by laminating a positive electrode as an electrode, a negative electrode as an electrode, and a separator. In the present embodiment, the battery case 22 is formed of a laminate film, and the electrode body 40 is sealed with the laminate film.

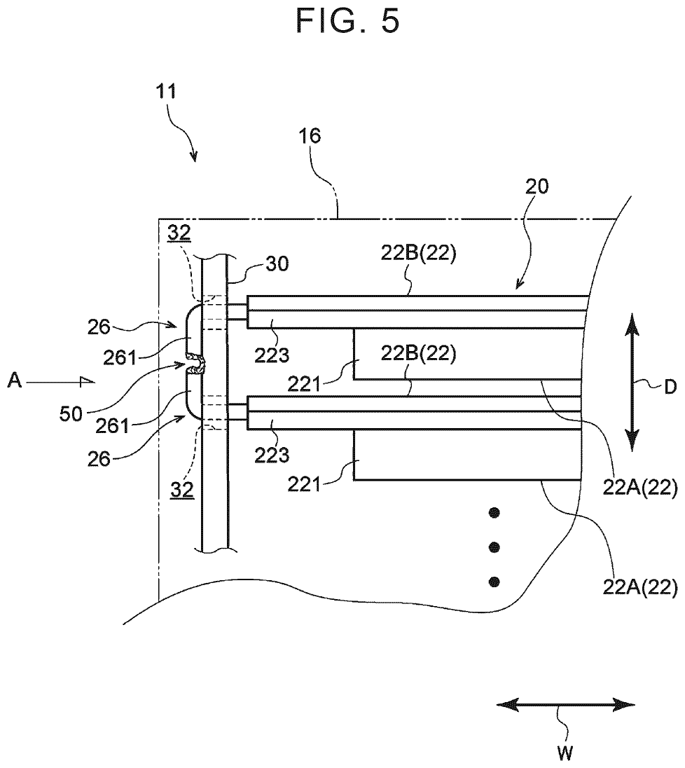

The battery case 22 is embossed in at least one of the thickness directions of the battery case 22. By embossing, a concave housing portion 221 in which the electrode body 40 is accommodated and an outer end portion 223 provided outside the housing portion 221 are formed on the side surface. Note that the battery case 22 may adopt both a single-cup embossing structure in which embossing is performed at one place and a double-cup embossing structure in which embossing is performed at two places. In the present embodiment, the battery case 22 has a single-cup embossing structure of about 10 mm from the drawing depth 8 mm. Therefore, the battery case 22 has one first side surface 22A in the thickness direction as an embossed surface on which embossing is performed, and the other second side surface 22B in the thickness direction (see FIG. 5) is a non-embossed surface on which embossing is not performed.

The upper end of the battery case 22 in the width direction is bent, and the corners are chamfered to have a substantially trapezoidal shape. Further, the upper end portion of the battery case 22 is bent, and the fixing tape 24 is wound around the upper end portion of the battery case 22 along the width direction.

Here, the battery cell 20 includes an electrode lead 26 protruding from an end portion of the battery case 22. The electrode leads 26 are provided at both end portions in the width direction of the battery cell. In the present embodiment, as an example, the electrode lead 26 is provided at a position offset downward from the center of the battery cell 20 in the height direction H. One end of the electrode lead 26 is connected to the electrode body 40 inside the battery case 22. The other end of the electrode lead 26 protrudes from the end in the width direction of the battery case 22 and is electrically connected to the bus bar 30 via a welded portion 50 (see FIG. 5). The electrode lead 26 is connected to an external wiring of the battery module 11 via the bus bar 30. The electrode lead 26 and the bus bar 30 may be welded by a known welding method as appropriate, but in an example of the present embodiment, the electrode lead 26 and the bus bar 30 are joined by laser welding.

The vehicle-width-direction length CW1 of the battery cell 20 is, for example, from 530 mm to 600 mm, the length CW2 of the area in which the electrode body is accommodated is, for example, from 500 mm to 520 mm, and the height CH of the battery cell 20 is, for example, from 80 mm to 110 mm. The battery cell 20 has a thickness from 7.0 mm to 9.0 mm, and the height TH of the electrode lead (terminal) 26 is from 40 mm to 50 mm.

FIG. 5 is a schematic plan view showing a state in which a plurality of battery cells 20 are accommodated in the module case 16 in a partially enlarged manner. As shown in this figure, in the module case 16, the other end of the electrode lead 26 protrudes from the end portion in the width direction W of the plurality of battery cells 20 stacked on each other. In addition, plate-shaped bus bars 30 are arranged on one side and the other side of the battery cell 20 in the width direction W, respectively.

In FIG. 5, for convenience of explanation, an interval is provided between the battery cells 20. However, in practice, the plurality of stacked battery cells 20 are in contact with each other via the cushioning material or directly, and are restrained from each other in a state where a predetermined restraining pressure is applied along the stacking direction (thickness direction D).

The bus bar 30 has the width direction W of the battery cells 20 as a plate thickness direction and extends along the stacking direction (thickness direction D) of the battery cells 20. In addition, a slot-shaped through hole 32 is formed in the bus bar 30 so as to penetrate the bus bar 30 in the plate thickness direction.

The other end of the electrode lead 26 protruding from the end portion of the battery cell 20 in the width direction W is inserted into the through hole 32 of the bus bar 30. Further, the end portion 261 protruding from the through-hole 32 is folded back toward the bus bar 30 side and overlaps the surface of the bus bar 30.

A plurality of through holes 32 are formed in the bus bar 30, and electrode leads 26 protruding from the plurality of battery cells 20 are inserted into the through holes 32 and joined to the bus bar 30. Accordingly, the plurality of battery cells 20 are electrically connected via the bus bar 30. FIG. 5 shows a state in which the electrode lead 26 protruding from the two battery cells 20 is joined to the bus bar 30 via the welded portion 50. As shown in FIG. 5, each of the two electrode leads 26 is inserted into a through hole 32 formed in the bus bar 30. The distal end portions 261 of the two electrode leads 26 are folded back toward the bus bar 30 in a direction approaching each other. As a result, the ends of the two electrode leads 26 are disposed close to each other on the surface of the bus bar 30. The end portions 261 of the two electrode leads 26 are joined to the bus bar 30 via the welded portion 50.

In the illustrated example, the end portions of the two electrode leads 26 are close to each other in a state of being separated from each other, but the end portions of the two electrode leads 26 may be in contact with each other.

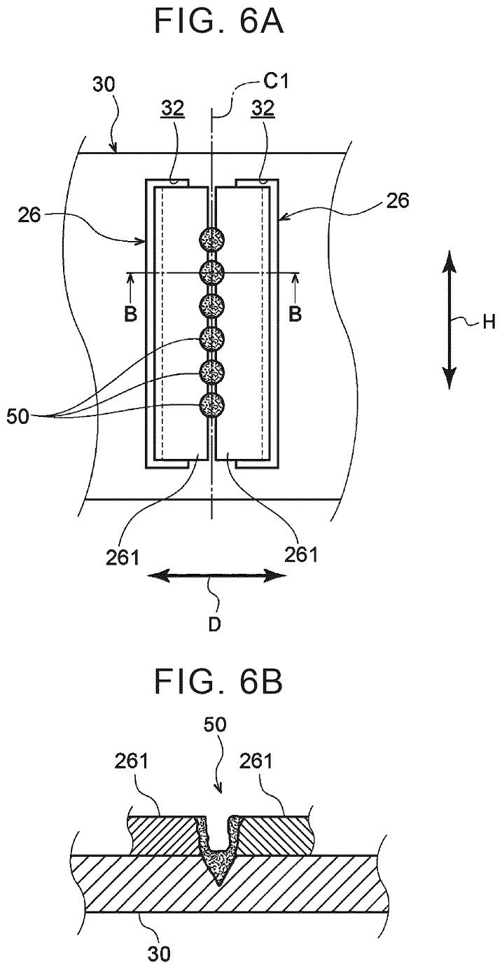

FIG. 6A is an enlarged front view of the welded portion 50 seen from the arrow A direction of FIG. 5. FIG. 6B is an enlarged cross-sectional view of the welded portion 50 taken along B-B line of FIG. 6A.

As shown in FIGS. 6A and 6B, the welded portion 50 is formed across the ends of the two electrode leads 26 on the surface of the bus bar 30 where the ends of the two electrode leads 26 approach each other. As a result, the end portions 261 of the two electrode leads 26 are simultaneously joined to each other with the thickness direction of the bus bar 30 as the joining direction. Further, since the welded portion 50 is formed by spot welding using a laser, it is formed in a circular dot shape when viewed from the joining direction of the welded portion 50 (the plate thickness direction of the bus bar 30).

In the present embodiment, the end portions 261 of the two electrode leads 26 are disposed to face each other in the thickness direction D of the battery cell 20, and a plurality of welded portions 50 are formed along the center line CI between the end portions 261.

At least one of the electrode lead 26 and the bus bar 30 has a heat input portion 60 formed in the welded portion 50, the heat input portion having a higher heat input property in the joining direction than the other portions. As an example, the heat input portion 60 is formed by surface processing of at least one of the electrode lead 26 and the bus bar 30. When the heat input portion 60 enhances the heat input property of the welded portion 50, penetration of the base material of the welded portion 50 becomes deep, and the bonding between the electrode lead 26 and the bus bar 30 can be stabilized.

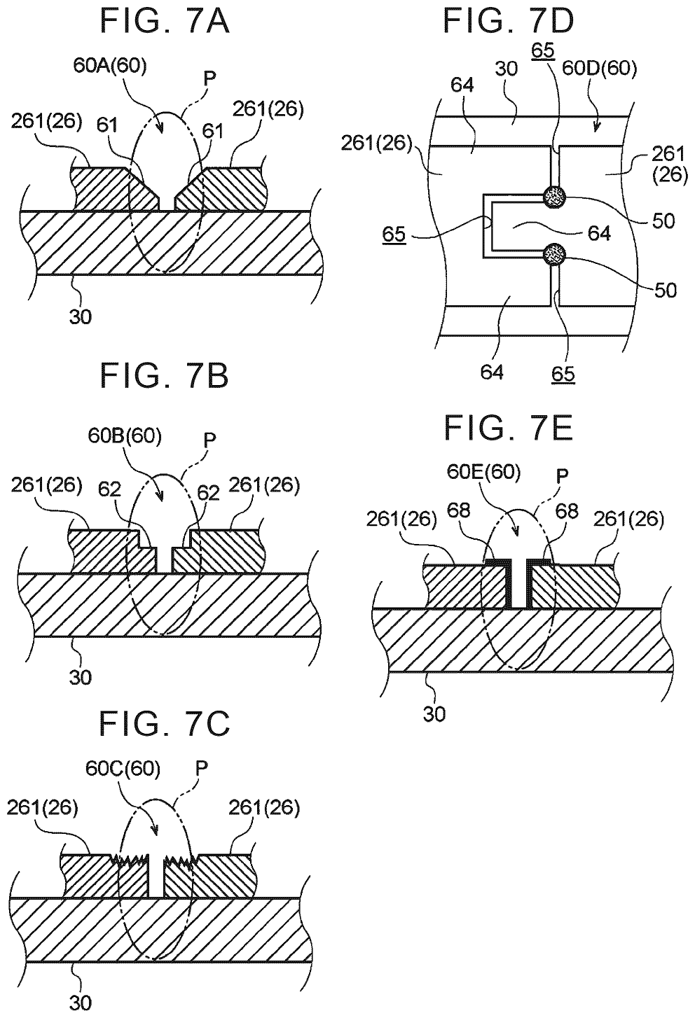

Referring to FIGS. 7A to 7E, an exemplary heat input portion 60 will be described. Here, a plurality of examples in which the heat input portion 60 is formed by surface processing to the electrode lead 26 will be described. However, the configuration of each heat input portion 60 may be provided in the bus bar 30, or may be provided in both the electrode lead 26 and the bus bar 30. Note that each figure shows a state before the welded portion 50 is formed in the electrode lead 26 and the bus bar 30 which are base materials, and the welded region is indicated by a region P surrounded by a two-dot chain line.

In the embodiment shown in FIGS. 7A to 7D, the heat input portion 60 is formed by surface processing for increasing the surface area of the welded portion 50.

The first heat input portion 60A shown in FIG. 7A forms an inclined surface 61 at the end portion 261 of the electrode lead 26, thereby increasing the surface area of the welded portion 50. In addition, since the inclined surface 61 is formed, the plate thickness of the end portion 261 of the electrode lead 26 is reduced toward the center side of the welding range P. As a result, the heat input property on the center side of the welded portion 50 can be increased more than on the outer peripheral side, and the bonding strength can be efficiently increased.

In the second heat input portion 60B shown in FIG. 7B, the step portion 62 is formed at the end portion 261 of the electrode lead 26, and the surface area of the welded portion 50 is increased. In addition, since the step portion 62 is formed, the plate thickness of the end portion 261 of the electrode lead 26 close to the center side of the welding range P becomes thinner than the plate thickness of the outer peripheral side. As a result, the heat input property on the center side of the welded portion 50 can be increased more than on the outer peripheral side, and the bonding strength can be efficiently increased.

In the third heat input portion 60C shown in FIG. 7C, the end portion 261 of the electrode lead 26 is roughened more than the other portions, and the surface area of the welded portion 50 is increased.

Further, the fifth heat input portion 60E shown in FIG. 7D is formed by alternately forming the convex portion 64 protruding along the surface of the bus bar 30 at the end portion 261 of the electrode lead 26 and the concave portion 65 retreated with respect to the convex portion 64, and the convex portion 64 and the concave portion 65 of the two electrode leads 26 are arranged so as to mesh. In the heat input portion 60E, for example, the welding range P is provided at a position where the convex portion 64 and the concave portion 65 engage with each other, so that the facing area (surface area) between the end portions 261 can be increased.

On the other hand, in the fourth heat input portion 60D shown in FIG. 7E, the heat input portion 60 is formed by surface-processing in which the black material 68 is applied to the end portion 261 (welded portion 50) of the electrode lead 26. As a result, the black material 68 absorbs the laser light, the heat input property of the welded portion 50 is enhanced, and the penetration of the base material can be deepened.

### Action and Effect

As described above, the battery module 11 according to the embodiment includes a plurality of battery cells 20 stacked on each other. The electrode lead 26 protruding from each battery cell 20 is electrically connected to the bus bar 30 via the welded portion 50. Here, the welded portion 50 joining the electrode lead 26 and the bus bar 30 is formed so as to straddle the end portions 261 of the plurality of electrode leads 26 on the surface of the bus bar 30 where the end portions 261 of the plurality of electrode leads 26 approach each other. As a result, the plurality of electrode leads 26 can be simultaneously joined to the bus bar 30 side through the common welded portion 50, and the number of welding steps can be reduced. In addition, since the welded portion 50 is formed so as to straddle the end portions 261 of the plurality of electrode leads 26, the output of the welding machine can be made low as compared with a configuration in which the end portions of the plurality of electrode leads are welded one on top of the other along the joining direction, thereby reducing the cost of welding.

In the present embodiment, the welded portion 50 is formed in a dot shape as viewed from the joining direction of the welded portion 50. Therefore, the plurality of electrode leads 26 can be simultaneously joined to the bus bar 30 side via the dot-shaped welded portion by laser welding or the like. As a result, the range of the welded portion 50 can be reduced, distortion and weld burning of the base material due to welding heat can be suppressed, and the number of steps in the finishing process can be reduced.

In the present embodiment, as shown in FIGS. 7A to 7E, the welded portion 50 is formed with a heat input portion 60 in which the heat input property in the joining direction is higher than that in the other portions in at least one of the electrode lead 26 and the bus bar 30. As a result, the penetration of the base material of the welded portion 50 can be deepened by the heat input portion 60, and the bonding can be stabilized.

In the embodiment shown in FIGS. 7A to 7D, the surface area of the welded portion 50 is increased by the surface processing of the heat input portion 60 (60A to 60D) in the welded portion 50, thereby enhancing the heat input property toward the joint. As a result, penetration of the base material of the welded portion 50 can be deepened, and the bonding can be stabilized.

On the other hand, in the exemplary embodiment shown in FIG. 7E, the welded portion 50 is coated with the black material 68 on the welded portion 50 by the surface-processing of the heat input portion 60E, so that the heat-input property in the joining direction is enhanced. As a result, penetration of the base material of the welded portion 50 can be deepened, and the bonding can be stabilized.

Although one embodiment and one modification example have been described above, the present disclosure can be implemented with various modifications without departing from the gist thereof. Needless to say, the scope of the present disclosure is not limited to the above-described embodiments.

For example, in the above embodiment, the end portions of the two electrode leads are joined together, but the present disclosure is not limited thereto. On the surface of the bus bar, the ends of the three or more electrode leads 26 may be brought close to each other, and a welded portion may be formed so as to straddle these ends.

What is claimed is:

1. A battery module comprising:
a plurality of battery cells stacked on each other;
electrode leads that protrude from the battery cells; and
a bus bar electrically connected to the electrode leads via a welded portion, the welded portion being formed to extend between respective end portions of the electrode leads on a surface of the bus bar on which the end portions of the electrode leads are close to each other.

2. The battery module according to claim 1, wherein the welded portion is formed in a dot shape when seen in a joining direction of the welded portion.

3. The battery module according to claim 1, wherein a heat input portion is formed at the welded portion in at least either of the electrode leads and the bus bar, the heat input portion having a higher heat input property in a joining direction than other portions.

4. The battery module according to claim 3, wherein the heat input portion is formed by surface processing to increase a surface area of the welded portion.

5. The battery module according to claim 3, wherein the heat input portion is formed by surface processing to apply a black material to the welded portion.
